(19) United States
(12) Patent Application Publication
(10) Pub. No.: US 2019/0299211 A1
(43) Pub. Date: Oct. 3, 2019

(54) MICROFLUIDIC CONTROL SCHEDULER CIRCUIT AND LAP-ON-A-CHIP INCLUDING THE SAME

(71) Applicant: POSTECH ACADEMY-INDUSTRY FOUNDATION, Pohang-si (KR)

(72) Inventors: Wan Kyun Chung, Pohang-si (KR); Junsu Kang, Gangjin-gun (KR); Young Jin Heo, Pohang-si (KR); Donghyeon Lee, Asan-si (KR)

(21) Appl. No.: 16/132,582

(22) Filed: Sep. 17, 2018

(30) Foreign Application Priority Data
Mar. 27, 2018 (KR) 10-2018-0035371

(51) Int. Cl. B01L 3/00; F16K 99/00

(52) U.S. Cl. CPC B01L 3/502738; F16K 99/0015; B01L 2400/0638; B01L 2300/0861; B01L 2400/0487; B01L 2200/0621

(57) ABSTRACT

Provided are a microfluidic control scheduler circuit and a the lab-on-a-chip. The microfluidic control scheduler circuit includes an input channel serving as a flow path between an input port and a membrane capacitor, a gate supply channel serving as a flow path between the membrane capacitor and a main valve, a gate supply port connected to the gate supply channel via a fluid resistance channel and a relief valve, and a scheduler module including an output channel serving as a flow path between a source supply port and an output port via the main valve, wherein the scheduler module is provided in plurality. The microfluidic control scheduler circuit and the lab-on-a-chip according to the present disclosure may sequentially and independently control a certain process without external control, thereby automating the lab-on-a-chip for processing a microfluid.

### BACKGROUND OF THE INVENTION

### Field of the Invention

The present disclosure relates to a microfluidic control scheduler circuit and a lab-on-a-chip including the same, and more particularly to a microfluidic control scheduler circuit which may be independently driven without external equipment or additional circuitry in a lab-on-a-chip and a lab-on-a-chip including the same.

### Related Art

In general, microfluidic lab-on-a-chip equipment requires assistance of an external controller to perform a complex, sequential process. Commonly used methods include manipulating water droplets according to electric signals through electrowetting, controlling microvalves through pneumatic from the outside, and the like. However, chips driven by external control equipment may only be used in a laboratory or hospital with an infrastructure environment and the number of chips that can be operated simultaneously may be limited depending on an acceptance limit of control equipment. This makes an on-site inspection impossible and lowers utilization of lab-on-a-chip in hospitals where many patients are to be examined or biotechnology and chemistry experiments where a variety of conditions are to be tested at the same time. In order to compensate for this, a method of sequentially transferring a solution using valves which are opened after a certain delay time has been proposed but this method has a limitation in the number of processes that can be realized and cannot disadvantageously realize a recursive process because each valve cannot return to a state before it was used. Another approach is to design a hydrodynamic transducer and utilize periodic fluid flow or input therefrom in a process. This method has been used for simple operations such as driving a peristaltic pump, generating a droplet, and the like. US Patent Laid-Open Publication No. US 20110301535 discloses such a hydrodynamic oscillator and US Patent Publication No. US20140079571 disclosed such a micro peristaltic pump. However, the method using the hydrodynamic transducer has limitations in that time of each step cannot be independently controlled or only a limited number of steps is repeated.

### SUMMARY OF THE INVENTION

The present disclosure provides a hydrodynamic monostable multivibrator circuit in which a signal is sequentially transferred to each scheduler module and an activation time of each step is independently regulated.

In an aspect, a microfluidic control scheduler circuit includes: an input channel serving as a flow path between an input port and a membrane capacitor; a gate supply channel serving as a flow path between the membrane capacitor and a main valve; a gate supply port connected to the gate supply channel via a fluid resistance channel and a relief valve; and a scheduler module including an output channel serving as a flow path between a source supply port and an output port via the main valve, wherein the scheduler module is provided in plurality.

When pressure at the gate supply channel is increased, a fluid may move through the fluid resistance channel and the relief valve from the gate supply channel, and when pressure at the gate supply channel is decreased, the fluid moves through the fluid resistance channel to the gate supply channel.

The gate supply channel is configured to fluid-communicate with a gate of the main valve, and the main valve may be opened and the fluid of the output channel flows for a predetermined time in which pressure at the gate supply channel is reduced and the fluid flows to the fluid resistance channel to recover reference pressure.

The relief valve may be opened when pressure applied to the gate supply channel is equal to or higher than predetermined pressure.

A gate of the relief valve may be connected to the output channel for fluid communication, and when pressure applied to the gate supply channel is higher than pressure applied to the output channel, the relief valve is opened.

The plurality of schedule modules may be configured such that when there is no input to the input port, pressure of the fluid supplied to the gate supply port and the source supply port is supplied within a predetermined range to close the main valve.

The plurality of scheduler modules may be configured such that pressure of the fluid transferred to an output port of at least one module acts on an input port of at least another module so that at least some of the plurality of modules sequentially generate an output.

The module may include a portion in which layers are stacked.

The fluid capacitor may include a chamber and a membrane dividing the chamber into a first sub-chamber and a second sub-chamber, the first sub-chamber may be connected to the input channel for fluid communication and the second sub-chamber may be connected to the gate supply channel for fluid communication.

When an external input is applied to the input port, the membrane may be deformed to transfer pressure to the inside of the gate supply channel and the fluid inside the gate supply channel may move for a first time from the inside of the gate supply channel to the gate supply port through the fluid resistance channel and the relief valve, and when the external input to the input port is released, the fluid inside the gate supply channel may flow for a second time from the gate supply port to the gate supply channel through the fluid resistance channel.

The fluid supplied to the gate supply channel may be an incompressible fluid.

In another aspect, a lap-on-a-chip includes: a microfluidic control scheduler circuit; a pneumatic logic circuit controlled in process according to a scheduling result based on the scheduler circuit; and a reaction chamber configured to perform a process according to an output from the pneumatic logic circuit, wherein the microfluidic control scheduler circuit includes a plurality of scheduler modules, and each of the plurality of scheduler modules includes: an input channel serving as a flow path between an input port and a membrane capacitor; a gate supply channel serving as a flow path between the membrane capacitor and a main valve; a gate supply port connected to the gate supply channel via a fluid resistance channel and a relief valve; and a scheduler module including an output channel serving as a flow path between a source supply port and an output port via the main valve.

### BRIEF DESCRIPTION OF THE DRAWINGS

FIG. 1 is a conceptual view of the related art microfluidic scheduler module;

FIG. 2 is a conceptual view of a microfluidic scheduler module according to the present disclosure;

FIG. 3 is an exploded perspective view of a microfluidic scheduler module;

FIG. 4 is a circuit diagram illustrating a microfluidic scheduler module as an electrical element;

FIG. 5 is a conceptual view of a membrane capacitor;

FIG. 6 is a conceptual view of a membrane valve;

FIG. 7 is a conceptual view of a lab-on-a-chip according to the present disclosure;

FIG. 8 is an enlarged view of a concept of a reaction chamber of FIG. 7;

FIG. 9 is an enlarged view illustrating a concept of a pneumatic logic circuit of FIG. 7.

### DESCRIPTION OF EXEMPLARY EMBODIMENTS

Hereinafter, a microfluidic control scheduler circuit and a lab-on-a-chip including the same according to an embodiment of the present disclosure will be described in detail with reference to the accompanying drawings. In the following description of the embodiments, the names of the respective components may be referred to by other names in the art. However, if the components have functional similarity and sameness, they may be considered as equivalent components although modifications thereof are employed. In addition, reference numerals added to the respective components are described for convenience of explanation. However, the illustrated contents on the drawings in which these reference numerals are shown to not limit the respective components to the coverage in the drawings. Likewise, although an embodiment in which some components of the drawings are modified is employed, the components may be considered to be the same if there are functional similarity and sameness. Further, in view of the level of ordinary skill in the art, if a component is recognized to be included, a description thereof will be omitted.

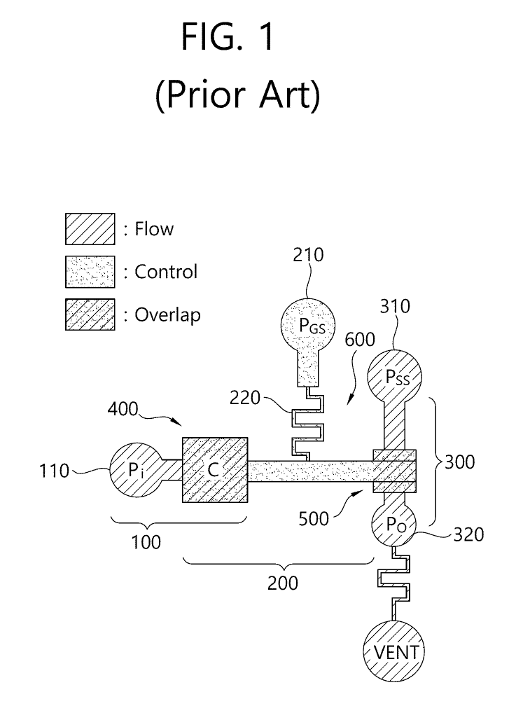

FIG. 1 is a conceptual view of the related art microfluidic scheduler module 1. As illustrated, a configuration in which a monostable multivibrator is used as a unit circuit in the related art layer-based microfluidic scheduler module 1 is shown. Blue and yellow are channels in different layers, there are overlapping portions, and the overlapping portions are blocked by elastic membranes m. When an input pulse is introduced, the monostable multivibrator serves to generate an output pulse the instant the input pulse ends. When the module is connected in series, a basic scheduler circuit in which each oscillator sequentially generates signals as signals are transmitted. Here, a time for each oscillator to generate an output pulse is determined in proportion to a hydrodynamic resistance value and hydrodynamic capacitance of the oscillator. However, in the monostable multivibrator, a length of the output pulse is not independent from a length of the input pulse, and thus, there is a limitation in the length of the output pulse that may be generated when an input pulse of a predetermined length is introduced. That is, when the input pulse is introduced, a portion of a fluid moves to a gate source port 210 side through fluid resistance, but the amount of the fluid is determined on the basis of fluid resistance and capacitance. When the input pulse is long, the output pulse is long, and when the input pulse is short, the output pulse is also short. In such a configuration, a problem is that the output pulse may not be configured independently of the input pulse.

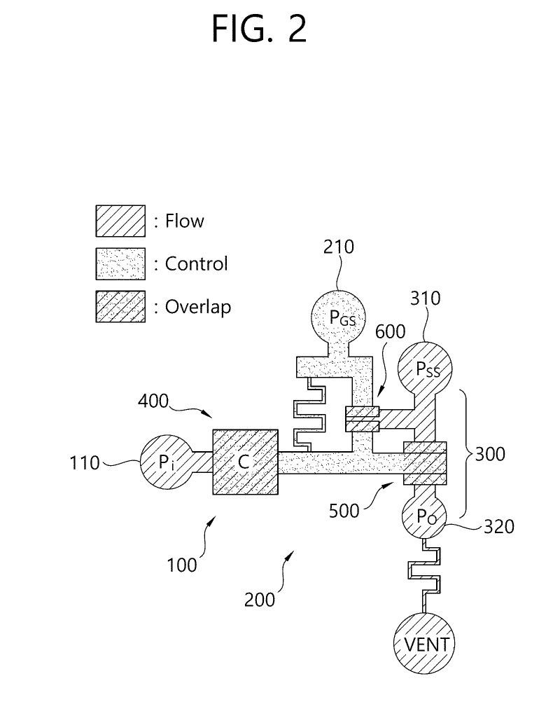

FIG. 2 is a conceptual view of the microfluidic scheduler module 1 according to the present disclosure. As illustrated, the microfluidic scheduler module 1 according to the present disclosure is based on the configuration of the monostable multivibrator illustrated in FIG. 1 and further includes a relief valve 600.

The microfluidic scheduler module 1 according to the present disclosure includes a plurality of channels which are independently configured to prevent fluid movement therebetween but may be affected each other in pressure.

Specifically, the microfluidic scheduler module 1 may include an input channel 100, a gate supply channel 200, and an output channel 300.

The input channel 100 is configured to receive an input pulse from the outside. The input channel 100 may have an input port 110 on one side thereof and the other side thereof may be connected to a first chamber 410, one side chamber of a membrane capacitor 400. Accordingly, when pressure is transmitted to the input port 110 from the outside, the fluid may move to one side of the membrane capacitor 400 to transmit pressure to a second chamber 420, which is on the opposite side with respect to the membrane m.

The gate supply channel 200 is provided to serve as a scheduler to change flow of the fluid when an input pulse is received from the outside. The gate supply channel 200 may be connected to the second chamber 420 of the membrane capacitor 400 described above, may be configured to allow the fluid to flow therein, and may be connected to a gate 510 side of a main valve 500. Thus, when pressure is transferred from the input channel 100 to the membrane capacitor 400, the membrane m is deformed toward the second chamber 420 and the fluid on the second chamber 420 side transfers pressure to the gate of the main valve 500.

The gate supply channel receives the fluid from the gate supply port and the gate supply port 210 is configured to communicate for the fluid with the gate supply channel 200 through a fluid resistance channel 220 and the relief valve 600. Thus, fluid movement between the gate supply channel 200 and the gate supply port 210 is freely made in the fluid resistance channel 220 and, alternatively, when the relief valve 600 is opened, fluid movement is selectively made.

The gate supply port 210 is connected to a flow channel 620 of the relief valve 600 opposite to the main valve 500. Meanwhile, the gate 610 side of the relief valve 600 is connected to the output channel 300 to receive pressure of the fluid.

The output channel 300 is configured to generate an output pulse at the output port 320. The output channel 300 serves as a flow path from a source supply port 310 to the output port 320. The output port 320 may be connected to a vent channel so that the output pulse generated at the output port 320 may be discharged to the outside and pressure is extinguished. Meanwhile, the fluid supplied to the gate supply port 210 may be an incompressible fluid to prevent loss of differential pressure due to compression. Also, the fluid supplied to the source supply port 310 and the gate supply port 210 may be selected to have the same or similar pressure and supplied. Here, the similar pressure is provided so that the valve may be driven by a pressure transferred from the outside.

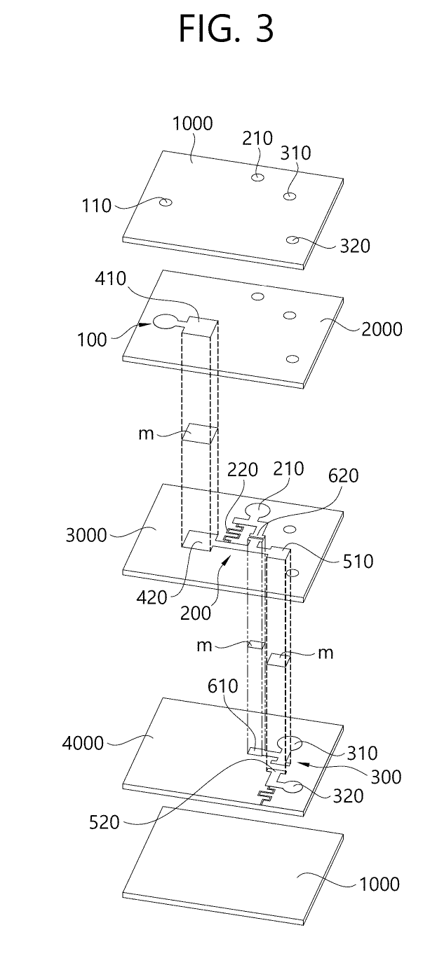

FIG. 3 is an exploded perspective view of the microfluidic scheduler module 1. As illustrated, the microfluidic scheduler module 1 according to the present disclosure may be formed on a layer basis and may be configured as a lab-on-a-chip, and each layer may have an empty space to serve as a channel or a chamber. As illustrated, the microfluidic scheduler module 1 may include a plurality of layers, e.g., five layers. Each layer includes the input channel 100, the gate supply channel 200, and the output channel 300 described above, and the membrane m may be provided in an overlapping space between the channels so as to perform a function of a valve or a capacitor.

The relief valve 600 is provided in the microfluidic scheduler module 1 to cause pressure of the capacitor to be returned to a predetermined level when an input pulse is introduced into the monostable multivibrator and to make pressure of the capacitor constant each time when an output pulse starts. Since the starting pressure is always constant, an output pulse is also generated for the same time each time.

The function of the microfluidic scheduler module 1 will be described in order of time as follows.

When a high pressure is instantaneously applied to the input port 110, the increased pressure overpasses the membrane capacitor 400 and is transferred to the gate supply channel 200. When pressure in the channel is increased due to the transfer of the pressure to the gate supply channel 200, pressure is increased at the gate 510 of the main valve 500, the fluid resistance channel 220, and the flow channel 620 of the relief channel 600. Accordingly, a fluid moves from the gate supply channel 200 side to the gate supply port 210 side, and here, the fluid moves through the fluid resistance channel 220 and the relief valve 600. Here, the relief valve 600 is opened due to a pressure difference of the valve, and the main valve 500 is closed.

When the input pulse is terminated, a force for restoring the membrane m to the original position acts on the membrane capacitor 400 to lower the pressure of the second chamber 420, and the pressure in the gate supply channel 200 is immediately lowered. When the pressure in the gate supply channel 200 is lowered, the pressure of the gate 510 of the main valve 500 is lowered, and thus, the main valve 500 is opened. Also, since the pressure of the flow channel 620 of the relief valve 600 is lowered but the pressure of the gate 610 is maintained, the relief valve 600 is closed. Accordingly, a pressure difference is generated and the fluid flows from the gate supply port 210 to the gate supply channel 200 through the fluid resistance channel 220. Here, a duration in which the fluid flows from the gate supply port 210 to the gate supply channel 200 and the pressure is stabilized to close the main valve 500 is a time for generating the output pulse.

Referring to only the operation of the relief valve 600, when the input pulse is generated, the relief valve 600 transfers the fluid to the gate supply port 210 together with the fluid resistance channel 220, and when the input pulse is terminated, the relief valve 600 closes the flow channel 620 to block movement of the fluid. Therefore, it is possible to generate a significant pressure difference between the gate supply channel 200 and the gate supply port 210, irrespective of the length of the input pulse. Without the relief valve 600, the pressure difference between the gate supply channel 200 and the gate supply port 210 is generated to be proportional to a duration of the input pulse, and thus, the disadvantage that the length of the input pulse must be long to generate a significant pressure difference may be overcome. For example, in case where the input pulse is generated for a very short time, but enough fluid can be flowed through the relief valve 600, the length of the output pulse of the microfluidic scheduler module 1 may be determined according to a relationship between capacity of the membrane capacitor 400 and fluid resistance of the fluid resistance channel 220. In case where a plurality of modules are provided, capacitance of each of the membrane capacitors 400 and the structure of the fluid resistance channel 220 may be varied to have independent lengths of output pulses.

Since the microfluidic scheduler module 1 according to the present disclosure generates an output pulse having a unique length at the end of an input pulse, if a scheduler circuit is configured through serial connection, each monostable multivibrator may sequentially generate a pulse having a unique length and may use the pulse as a signal for sequentially performing a process having a sequence.

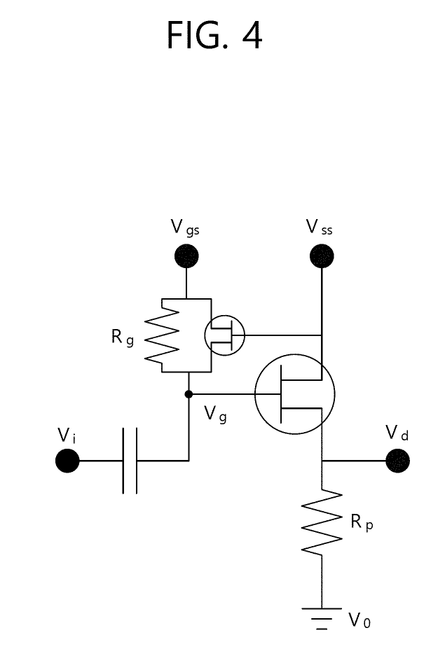

FIG. 4 is a circuit diagram illustrating the microfluidic scheduler module 1 as an electrical element.

The microfluidic scheduler module 1 includes a resistor, a capacitance, and a MOFSET with respect to the input port, the gate supply port, the source supply port, and the output port. And the relief valve and the main valve may perform a function of a MOSFET that generate an output pulse according to a voltage difference.

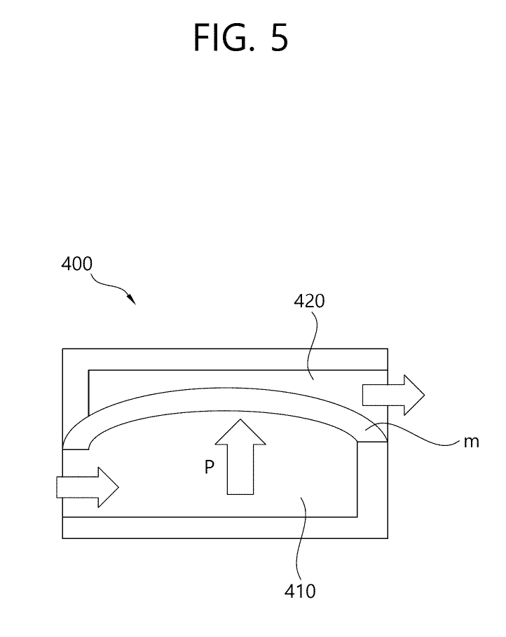

FIG. 5 is a conceptual view of the membrane capacitor 400. In the cross-section of the membrane capacitor 400 as illustrated, a chamber is formed by a space formed between two layers, and the membrane m is provided so that the first chamber 410 and the second chamber 410 are distinguished from each other with respect to the membrane m. When pressure of any one of the first chamber 410 and the second chamber 420 is relatively changed, the membrane m is deformed to correspond to the changed pressure. The deformed membrane (m) transfers pressure, while storing energy.

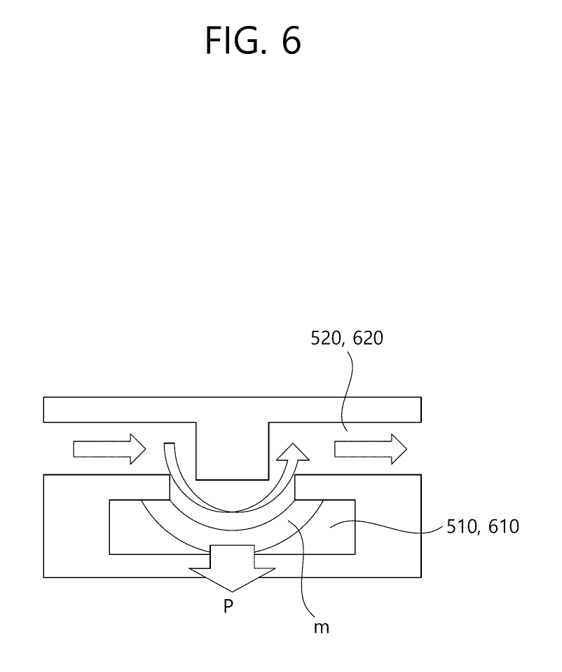

FIG. 6 is a conceptual view of a membrane valve. Similar to the membrane capacitor 400 described above, the membrane valve is opened and closed depending on a pressure difference between the both sides with respect to the membrane m. When pressure at the gate 510 formed on the lower side of FIG. 6 is higher than pressure at the flow channel 520 formed on the upper side, the valve is closed, and when pressure at the lower gate 510 is lower than the upper flow channel 520, the valve is opened to allow a fluid to flow.

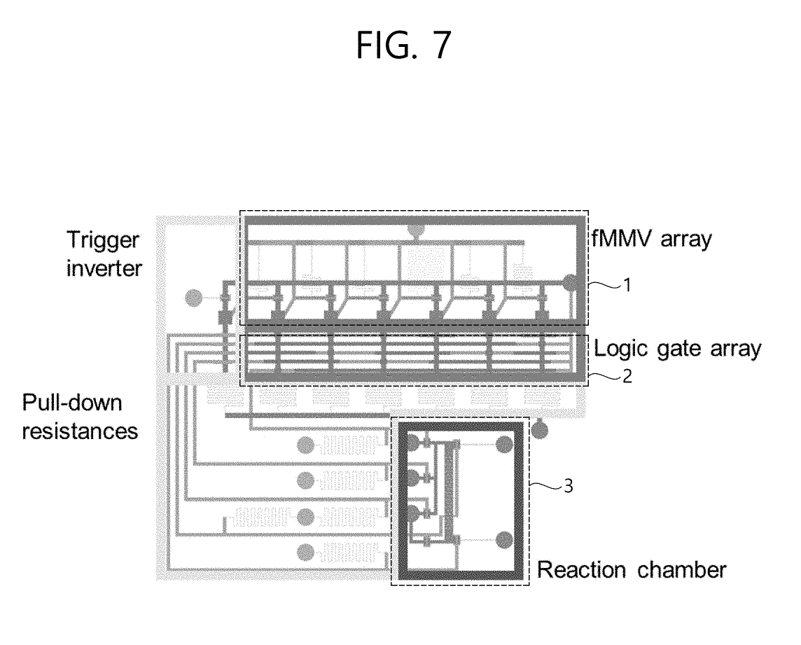

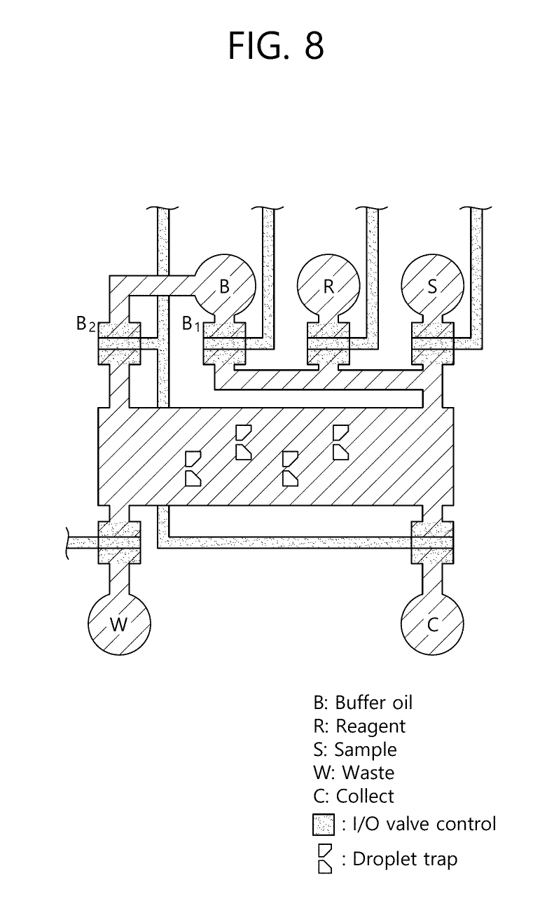

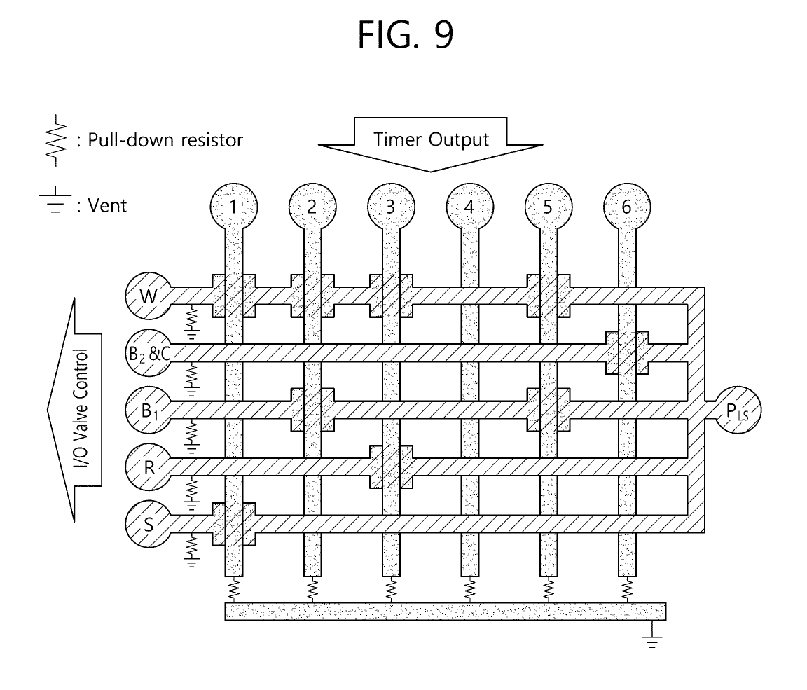

FIG. 7 is a conceptual view of a lab-on-a-chip according to the present disclosure, FIG., and FIG. 8 is an enlarged view illustrating a concept of a reaction chamber of FIG. 7, FIG. 9 is an enlarged view illustrating a concept of a pneumatic logic circuit of FIG. 7.

The lab-on-a-chip according to the present disclosure may include a scheduler module 1, a pneumatic logic circuit 2, and a reaction chamber 3. The scheduler module 1 may be provided in plurality and may be configured to have a unique output pulse length according to each input as described above. The pneumatic logic circuit is configured such that a specific valve is selectively opened and closed when an output pulse is sequentially transmitted from the microfluidic scheduler. When the valve is selectively opened or closed, materials such as buffer oil, reagent or sample may be moved to in the reaction chamber according to predetermined order and period. Also middle to after of reaction, the valve is selectively opened or closed to move out materials such as product or waste

As described above, the microfluidic scheduler module 1 according to the present disclosure may generate an output pulse having a length independent of a length of an input pulse and may sequentially generate multiple independent outputs even without external control to implement a complicated process and simplify the configuration of the lab-on-a-chip.

The microfluidic control scheduler circuit and the lab-on-a-chip according to the present disclosure may sequentially and independently control a certain process without external control, thereby automating the lab-on-a-chip for processing a microfluid.

In the above exemplary systems, although the methods have been described on the basis of the flowcharts using a series of the steps or blocks, the present disclosure is not limited to the sequence of the steps, and some of the steps may be performed at different sequences from the remaining steps or may be performed simultaneously with the remaining steps. Furthermore, those skilled in the art will understand that the steps illustrated in the flowcharts are not exclusive and may include other steps or one or more steps of the flowcharts may be deleted without affecting the scope of the present disclosure.

What is claimed is:

1. A microfluidic control scheduler circuit comprising:
an input channel serving as a flow path between an input port and a membrane capacitor;
a gate supply channel serving as a flow path between the membrane capacitor and a main valve;
a gate supply port connected to the gate supply channel via a fluid resistance channel and a relief valve; and
a scheduler module including an output channel serving as a flow path between a source supply port and an output port via the main valve,
wherein the scheduler module is provided in plurality.

2. The microfluidic control scheduler circuit of claim 1, wherein
when pressure at the gate supply channel is increased, a fluid moves through the fluid resistance channel and the relief valve from the gate supply channel, and
when pressure at the gate supply channel is decreased, the fluid moves through the fluid resistance channel to the gate supply channel.

3. The microfluidic control scheduler circuit of claim 2, wherein
the gate supply channel is configured to fluid-communicate with a gate of the main valve, and
the main valve is opened and the fluid of the output channel flows for a predetermined time in which pressure at the gate supply channel is reduced and the fluid flows through the fluid resistance channel to recover reference pressure.

4. The microfluidic control scheduler circuit of claim 2, wherein
the relief valve is opened when pressure applied to the gate supply channel is equal to or higher than predetermined pressure.

5. The microfluidic control scheduler circuit of claim 4, wherein
a gate of the relief valve is connected to the output channel for fluid communication, and
when pressure applied to the gate supply channel is higher than pressure applied to the output channel, the relief valve is opened.

6. The microfluidic control scheduler circuit of claim 5, wherein
the module is configured such that when there is no input to the input port, pressure of the fluid supplied to the gate supply port and the source supply port is supplied within a predetermined range to close the main valve.

7. The microfluidic control scheduler circuit of claim 1, wherein
the plurality of scheduler modules are configured such that pressure of the fluid transferred to an output port of at least one module acts on an input port of at least another module so that at least some of the plurality of modules sequentially generate an output.

8. The microfluidic control scheduler circuit of claim 7, wherein
the plurality of scheduler modules are connected in series so that an output of any one scheduler transfers pressure as an input of a subsequent scheduler module.

9. The microfluidic control scheduler circuit of claim 2, wherein
the module includes a portion in which layers are stacked.

10. The microfluidic control scheduler circuit of claim 1, wherein
the fluid capacitor includes a chamber and a membrane dividing the chamber into a first sub-chamber and a second sub-chamber,
the first sub-chamber is connected to the input channel for fluid communication and
the second sub-chamber is connected to the gate supply channel for fluid communication.

11. The microfluidic control scheduler circuit of claim 10, wherein
when an external input is applied to the input port, the membrane is deformed to transfer pressure to the inside of the gate supply channel and the fluid inside the gate supply channel moves for a first time from the inside of the gate supply channel to the gate supply port through the fluid resistance channel and the relief valve, and
when the external input to the input port is released, the fluid inside the gate supply channel flows for a second time from the gate supply port to the gate supply channel through the fluid resistance channel.

12. The microfluidic control scheduler circuit of claim 1, wherein
the fluid supplied to the gate supply channel is an incompressible fluid.

13. A lap-on-a-chip comprising:
a microfluidic control scheduler circuit;
a pneumatic logic circuit controlled in process according to a scheduling result based on the scheduler circuit; and
a reaction chamber configured to perform a process according to an output from the pneumatic logic circuit,
wherein
the microfluidic control scheduler circuit includes a plurality of scheduler modules, and
each of the plurality of scheduler modules includes:
an input channel serving as a flow path between an input port and a membrane capacitor;
a gate supply channel serving as a flow path between the membrane capacitor and a main valve;
a gate supply port connected to the gate supply channel via a fluid resistance channel and a relief valve; and
a scheduler module including an output channel serving as a flow path between a source supply port and an output port via the main valve.

14. The lap-on-a-chip of claim 13, wherein
when pressure at the gate supply channel is increased, a fluid moves through the fluid resistance channel and the relief valve from the gate supply channel, and
when pressure at the gate supply channel is decreased, the fluid moves through the fluid resistance channel to the gate supply channel.
